(19) United States
(12) Patent Application Publication
(10) Pub. No.: US 2004/0062515 A1
(43) Pub. Date: Apr. 1, 2004

(54) Apparatuses and methods for imparting mechanical twist in optical fibers

(76) Inventors: Harry Douglas Garner JR., Gwinnett County, GA (US); Siu-Ping Hong, Fulton County, GA (US); James A. Hudson, Gwinnett County, GA (US); David Kalish, Fulton County, GA (US); Stephen Mast, Gwinnett County, GA (US); Alan H. McCurdy, Fulton County, GA (US); John Popwell, Gwinnett County, GA (US); John F. Ryan III, Duluth, GA (US); Gene Kent Weeks, Duluth, GA (US); Zhi Zhou, Gwinnett County, GA (US)

Correspondence Address: Fitel USA Corp., 2000 Northeast Expressway, Room 2H02, Norcross, GA, 30071, US

(21) Appl. No.: 10/427,305

(22) Filed: May 1, 2003

Related U.S. Application Data
(63) Continuation-in-part of application No. 10/255,751, filed on Sep. 26, 2002.

(51) Int. Cl. G02B 6/00

(52) U.S. Cl. 385/147

(57) ABSTRACT

Methods and apparatuses introduce mechanical twist to an optical fiber having relatively large polarization mode dispersion (PMD), such as unspun fiber or fiber spun with constant spatial frequency, which mechanical twist reduces the fiber's PMD. A spool of optical fiber having relatively large PMD is mounted and fiber is pulled from the end of the spool to impart a specified mechanical twist. Additionally, the spool may be controllably rotated by a control system while optical fiber is pulled therefrom, allowing the system to generate a precise amount of mechanical twist to the fiber. Also, it is possible to measure the amount of mechanical twist in an optical fiber and the amount of mechanical twist in an optical fiber as a function of fiber length.

### CROSS-REFRENCE TO RELATED APPLICATION

This invention is a Continuation-In-Part of U.S. application Ser. No. 10/255,751, filed Sep. 26, 2002.

### FIELD OF THE INVENTION

The present invention relates generally to apparatuses and methods for imparting fiber twist, and more particularly, to apparatuses and methods for imparting mechanical twist in optical fiber to reduce polarization mode dispersion (PMD) and to ensure optical fiber quality.

### BACKGROUND OF THE INVENTION

Communications and data transmission systems that transmit information signals in the form of optical pulses over optical fiber are now commonplace, and optical fibers have become the physical transport medium of choice in long distance telephone, data and video communication networks due to their signal transmission capabilities, which greatly exceed those of mechanical conductors. Despite their advantages, however, difficulties in their manufacture must be overcome in order for high-yield, high-quality and error-free optical fiber to be produced in mass.

Mechanical twist of an optical fiber changes PMD. PMD is undesirable, as it negatively impacts the performance of an optical fiber. Mechanical twist is caused by an external torque placed on the fiber core, which causes stress-induced birefringence that changes PMD in the optical fiber. Mechanical twist is illustrated in FIG. 1A. As shown in FIG. 1A, mechanical twist, represented by the directional arrow, is caused by an external twisting of the coating 2 of an optical fiber. This twisting causes a non-uniform stress on the glass fiber 4, resulting in changed PMD. Mechanical twist is distinguishable from fiber spin, which is permanently introduced into the fiber by the purposeful rotation of the optical fiber during the draw portion of the fiber manufacturing process. Fiber spin, illustrated by the directional arrow in FIG. 1B, is induced during formation of the optical fiber 4 by rotating the drawn glass that forms the optical fiber core and cladding.

### BRIEF SUMMARY OF THE INVENTION

Apparatuses and methods of the present invention impart a twist to an optical fiber such as optical fiber having a relatively large amount of polarization mode dispersion (PMD), which imparted twist reduces the fiber's PMD. Optical fiber having a relatively large amount of PMD includes, e.g., unspun fiber or fiber spun with constant spatial frequency. Briefly, a spool of high-PMD optical fiber is mounted and fiber is pulled from the end of the spool to impart a specified mechanical twist. Additionally, the spool may be controllably rotated by a control system while optical fiber is pulled there from, allowing the system to generate a precise amount of mechanical twist in the fiber.

According to one embodiment of the invention, there is a disclosed apparatus for imparting a mechanical twist to optical fiber. The apparatus includes a spool, having a central section and at least one flange end, and a pulling device, for pulling fiber, wrapped around the central section of the spool, from the spool. The pulling device pulls the fiber from the spool over the flange end of the spool, thereby imparting twist to the fiber. For fiber having a relatively large amount of PMD, such as unspun fiber or fiber spun with constant spatial frequency, the twist imparted by the apparatus reduces the PMD of the fiber.

According to one aspect of the invention, the fiber comprises optical fiber. According to another aspect of the invention, the pulling device pulls the fiber in a direction substantially perpendicular to the direction in which the fiber is wrapped around the central section of the spool. According to yet another aspect of the invention, the spool is secured such that it cannot rotate. According to a further aspect of the invention, the pulling device is operable to impart variable twist to the fiber depending upon the circumference of the spool.

According to one aspect of the invention, the spool may also be rotated as fiber is pulled from the spool by the pulling device. The apparatus may also include at least one motor that rotates the spool as fiber is pulled from the spool by the pulling device. Furthermore, according to one aspect of the invention, at least one motor is operable to rotate the spool in the clockwise and counterclockwise directions. At least one motor may also be in communication with at least one pulling device, where the at least one pulling device controls the motor and the speed at which the spool rotates.

According to another aspect of the invention, the apparatus for imparting mechanical twist can include a control system operable to control the speed at which the spool rotates. The control system, which may be in electrical communication with the pulling device, is operable to control the speed at which the spool rotates such that mechanical twist is imparted to the fiber.

According to another aspect of the invention, the apparatus for imparting mechanical twist in optical fiber can include one or more devices for measuring the amount of mechanical twist in optical fiber and/or measuring the mechanical twist as a function of fiber length. The devices, which may be controlled manually or automatically, measure and coordinate the amount of fiber payed out from the spool with the amount of mechanical twist in the payed out fiber.

According to another embodiment of the invention, there is a disclosed method for imparting mechanical twist to optical fiber. The method includes the steps of wrapping a fiber around a central section of a first spool having at least one flange end, pulling the fiber from the first spool over the flange end of the first spool, thereby imparting twist to the fiber, and wrapping the fiber having imparted twist around a second spool. For fiber having a relatively large amount of PMD, such as unspun fiber or fiber spun with constant spatial frequency, the method reduces the PMD of the fiber.

According to one aspect of the invention, wrapping fiber around a central section of the first spool includes wrapping optical fiber around a central section of the first spool. According to another aspect of the invention, pulling the fiber from the first spool over the flange end of the first spool includes pulling the fiber in a direction substantially perpendicular to the direction in which the fiber is wrapped around the central section of the first spool.

Additionally, according to one aspect of the invention, the first spool may be secured so that it cannot rotate. According to another aspect of the invention, the first spool is rotated as the fiber is pulled from the first spool by a pulling device. The method may also comprise the step of controllably rotating the first spool using at least one motor in communication with the pulling device. Furthermore, the speed at which the first spool rotates may be controlled as the fiber is pulled from the first spool using a control system. Finally, controlling the speed at which the first spool rotates can further include the step of controlling the speed at which the first spool rotates such that the desired variable or constant mechanical twist is imparted to the fiber.

According to another aspect of the invention, the method for imparting mechanical twist includes measuring the amount of mechanical twist in optical fiber and measuring the mechanical twist as a function of fiber length. The method, which may be manual or automatic, measures and coordinates the amount of fiber payed out from the spool with the amount of mechanical twist in the fiber.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1A shows mechanical twist of an optical fiber.

FIG. 1B shows fiber spin of an optical fiber.

FIG. 2 shows a graph illustrating the impact of mechanical twist on PMD, according to one illustrative example.

FIG. 3 illustrates a device for measuring the mechanical twist of a drawn optical fiber.

FIG. 4 shows an apparatus to effect passive twisting, according to one embodiment of the present invention.

FIG. 5 shows a cross-section of a spool having twisted fiber wound thereon, according to one illustrative example.

FIG. 6 is a graph illustrating the twist imparted to optical fiber on various diameter spools using passive twisting of a drawn optical fiber, according to one embodiment of the present invention.

FIG. 7 shows an apparatus to effect active fiber twisting, according to one embodiment of the present invention.

FIG. 8 is a graph illustrating the twist imparted to optical fiber for various diameter spools and spool rotation speeds using active fiber twisting, according to one embodiment of the present invention.

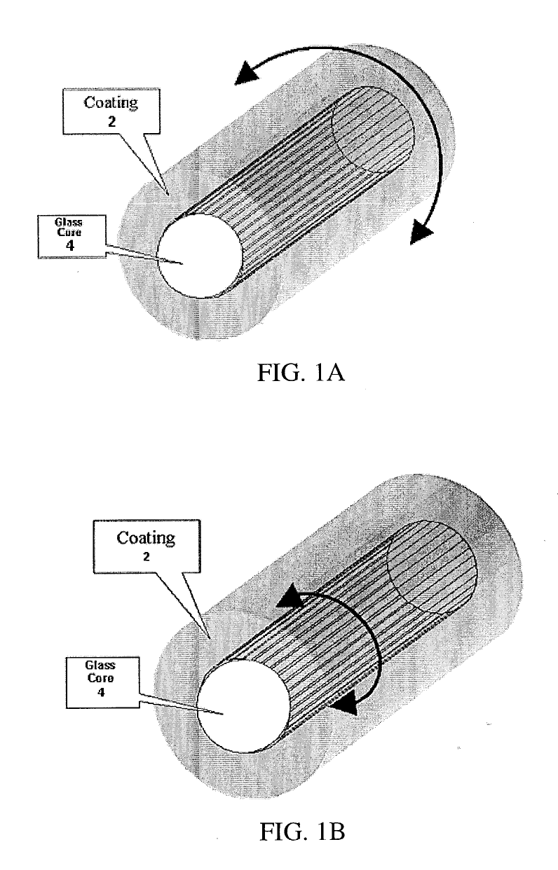

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

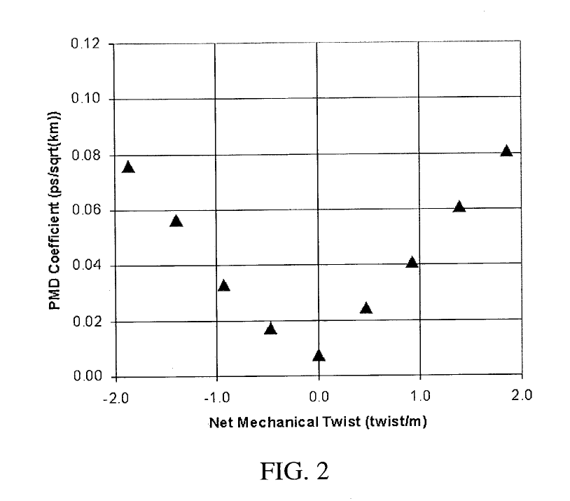

As previously discussed, mechanical twist of an optical fiber often introduces PMD, which negatively impacts the performance of an optical fiber. FIG. 2 shows a graph illustrating the impact of the mechanical twist on an optical fiber's PMD coefficient, according to an illustrative example in which PMD has been substantially reduced, e.g., in the manner disclosed in U.S. Pat. No. 5,298,047. As shown in the figure, a net mechanical twist value of near zero (0) results in the lowest PMD coefficient, where the mechanical twist value is measured in turns per meter, and the PMD coefficient is measured in picoseconds per \sqrt{km}. However, when the twist of the optical fiber deviates from near zero (0), the PMD coefficient increases in value. This holds true if the net mechanical twist is positive or negative in value, which corresponds, respectively, to a clockwise and counterclockwise twist of the optical fiber (or vice versa). In the embodiment of FIG. 2, the PMD coefficient is approximately 0.04 picoseconds per \sqrt{km} per twist per meter, which corresponds to the slope of the lines defined by the PMD coefficients for relative net mechanical twist values.

It will be appreciated by those of ordinary skill in the art that the specific values shown in FIG. 2 are for illustrative purposes only, and that PMD values for a particular optical fiber having varying degrees of mechanical twist will depend upon the characteristics of the optical fiber. Nevertheless, the general proposition signified by FIG. 2, which is that the PMD coefficient for an optical fiber will be at a minimum where the net mechanical twist is near zero (0), holds true for conventional optical fiber.

However, according to embodiments of the invention, although a net mechanical twist value of near zero results in the lowest PMD coefficient, for a fiber that has a relatively large PMD coefficient, such as unspun fiber or fiber spun with constant spatial frequency, introducing mechanical twist actually reduces the PMD coefficient.

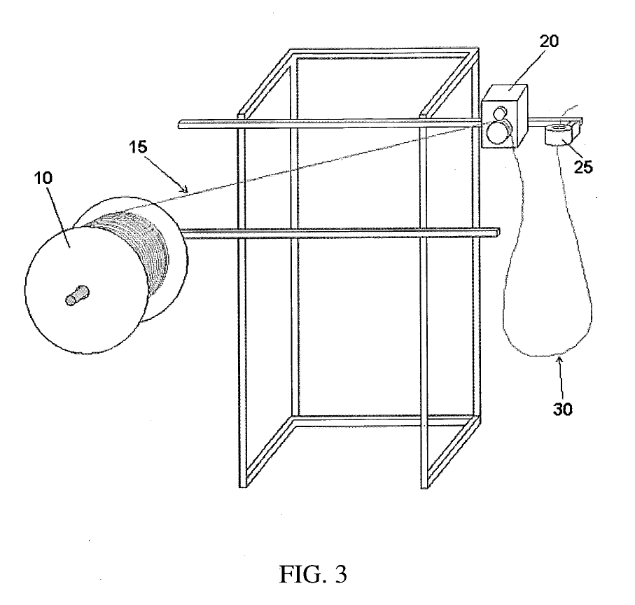

FIG. 3 shows a device for measuring the mechanical twist of each spool of optical fiber generated by a drawing process. Measuring the mechanical twist of each spool can serve two purposes. First, the measured mechanical twist is used by the systems, apparatuses and methods of the present invention to introduce, if needed, additional mechanical twist to a fiber, e.g., as part of a post-draw process. Secondly, the measured mechanical twist of each spool may be used to adjust the drawing tower such that mechanical twist is introduced to later-manufactured optical fiber.

As shown in FIG. 3, a spool 10 of optical fiber 15 is rotatably mounted on a post in a horizontal position such that the optical fiber 15 may be continuously pulled from the top or bottom of the spool 10 as the spool 10 rotates. The optical fiber 15 is threaded through a fiber payout device 20, which uses one or more revolving wheels to measure the length of optical fiber 15 passing there through. The end of the optical fiber 15 is then secured to a rotatable chuck device 25 and a length of fiber, such as 2 meters in length, is fed through the fiber payout device 20 to form a fiber loop 30 located in between the fiber payout device 20 and the rotatable chuck device 25. It will be appreciated that because the end of the optical fiber 15 relaxes or unwinds by itself on the spool 10 before it is secured to the rotatable chuck device 25, a length of fiber, such as 7-10 meters, is preferably removed from the spool 10 prior to securing the end of the fiber 15 to the chuck device 25.

Once the end of the fiber 15 is secured to the chuck device 25 and a fiber loop 30 is produced, the loop 30 is examined to determine whether there is mechanical twist present in the fiber 15. If there is no mechanical twist in the optical fiber 15, the fiber loop 30 will hang loosely, with no inclination to twisting relative to itself or about a vertical axis. However, where mechanical twist is present the optical fiber loop 30 will not hang freely, as tension in the loop will cause the loop 30 to bend or coil in a clockwise or counterclockwise fashion about a vertical axis. This twist is analogous to the manner in which a telephone cord will twist upon itself when one the end of the telephone cord fixed to a telephone base and the other end, which is attached to the handset, is spun in a clockwise or counterclockwise direction.

The presence or absence of mechanical twist is ascertained by a visual inspection of the fiber loop 30. After the presence of mechanical twist is confirmed, the mechanical twist, measured in turns per meter, is measured using the chuck device 25. In particular, the chuck device 25, to which the end the fiber 15 is secured, is rotated to counteract the effect of the twist in the fiber loop 30. Essentially, the chuck device is turned in the opposite direction of the twist in the fiber loop 30 until the fiber loop 30 hangs loosely and is void of any twist. During this process the total number of turns of the rotatable chuck device 25, measured in whole and fractional turns, is recorded. Using the total number of turns of the chuck device 25 and the length of the fiber loop 30 measured by the fiber payout device 20, the mechanical twist may be calculated:

$$Mechanical Twist ( turns \text{/} m ) = \frac{Number of turn s to release twist}{Length of fiber loop ( m )}$$

To account for variability of mechanical twist and possible operator error, a plurality of such measurements are preferably made for each spool and averaged together to give a final twist measurement for each spool. According to one preferred embodiment, at least three (3) such measurements each separated by 7-10 meters are made and averaged. Once the mechanical twist is measured and the fiber is determined to have relatively high PMD, apparatuses and methods of the present invention controllably introduce twist to the fiber to reduce PMD.

To measure the mechanical twist as a function of length along an optical fiber, a device such as a recorder continuously records the length encoder information from the fiber payout device 20 and the rotation angle from the rotatable chuck device 25 as the fiber is payed out from the spool to form the fiber loop while the chuck is rotated to maintain the hanging fiber loop in a relaxed state at all times with minimum mechanical twist. This is done either manually or automatically by a device such as a machine vision system or other device or technique capable of measuring the orientation of the hanging fiber loop. In this manner, the values recorded for the fiber length and orientation of the rotatable chuck device 25 will give a measure of the fiber orientation along the length, which values are used to determine the mechanical twist of the fiber as a function of length. These measurements are conveniently carried out, e.g., using a computer based data acquisition system to read the encoders for the fiber payout device 20 and rotatable chuck device 25. The data from this system is useful in subsequent analysis. To allow measurement of long fiber samples, it is possible to continuously feed the fiber through and clamp it until a new loop is required to provide an automatic means of making measurements on long fiber samples more convenient.

With an automated device for measuring the orientation of the hanging fiber loop, a feeder for continuously feeding the fiber through the apparatus maintaining a relatively constant length hanging fiber loop, and the ability to automatically adjust the rotatable chuck assembly in response to the fiber loop orientation measurement to maintain a constant orientation of the loop, a more fully automated measurement technique is realized, whereby the control signal that maintains the constant orientation of the fiber loop is a measure of the orientation of the fiber along the length. Such an automated device provides a relatively efficient and accurate way to measure the fiber orientation along its length and hence the mechanical twist with a reduced amount of human intervention. Also, such a device is useful in more accurately measuring substantially longer lengths of fiber than conventional techniques, thus providing more accurate and efficient measurement of mechanical twist in optical fiber.

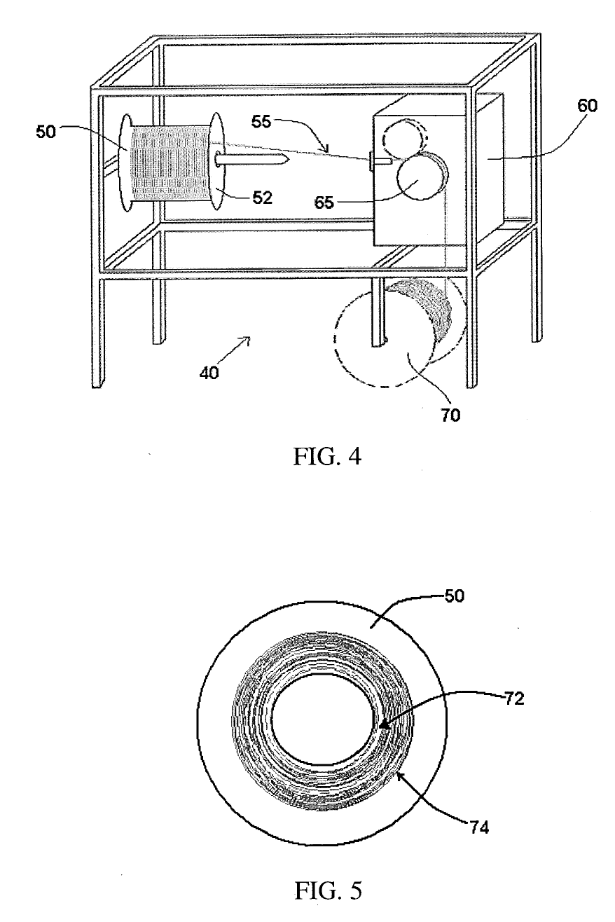

FIG. 4 shows an apparatus 40 to effect passive twisting, according to one embodiment of the present invention. As shown in FIG. 4, the spool 50 (the pay-out end) of optical fiber 55 is mounted on a post such that the end of the spool faces, and the spool's center axis intersects, a passive twisting device 60. According to one aspect of the invention, the spool 50 is fixed so that it cannot rotate. The apparatus 40 effects twisting of the fiber by pulling the optical fiber 55 from the flange end 52 of the spool 50 and winding it onto another spool 70 (the take-up end). The twisting device 60 includes a motor and at least one wheel 65 for pulling the fiber 55 from the spool 50. Mechanical twist is imparted to the fiber 55 as the fiber 55 is pulled over the end 52 of the spool 50. This twist is naturally generated as the fiber 55 is pulled over the flange end 50 due to the orientation of the spool 50 and passive twisting device 60. This twist reduces PMD in optical fiber, such as unspun optical fiber or fiber spun with constant spatial frequency, that has a relative large amount of PMD. According to one aspect of the invention, the apparatus 40 may be incorporated into the fiber manufacturing process, as it effects rewinding of the fiber 55.

The direction or orientation of the twists imparted to the fiber 55 (i.e., positive/negative twist or clockwise/counter clockwise twist) is dependent upon the orientation of the spool 50. The number of twists imparted to the fiber 55 is dependant upon the circumference of the spool 50, as one turn of mechanical twist is imparted for each length of optical fiber 55 corresponding to one spool 50 revolution. Therefore, as optical fiber 55 is removed from the spool 50, the length of optical fiber 55 associated with one spool revolution gradually decreases. This is illustrated in FIG. 5, which shows a cross-section of a spool 50 having optical fiber wound thereon. As the apparatus 40 removes optical fiber, the circumference of the wound optical fiber will gradually decrease from the fiber circumference shown at reference 74 to the fiber circumference shown at reference 72. Therefore, the amount of twist imparted to optical fiber wound on the spool 50 is not uniform along the length of the fiber, as greater twist is imparted for optical fiber 55 closest to the center of the spool 50 than for optical fiber 55 closer to the outside of the spool 50.

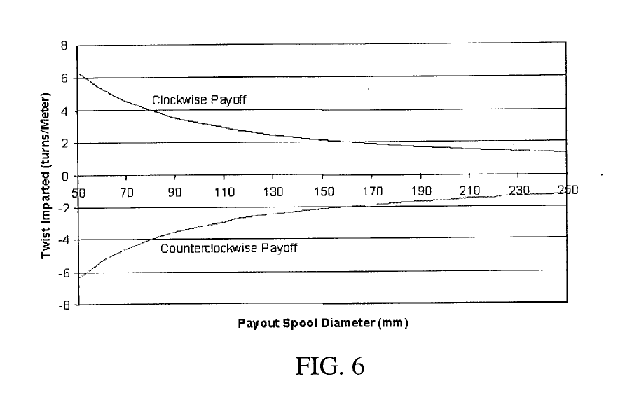

FIG. 6 shows the relationship of the amount of twist imparted, in terms of turns per meter, for varying spool 50 diameters, measured in millimeters (mm). The graph shows that the same amount of twist will be imparted whether the fiber 55 is removed from the spool 50 in a clockwise and counterclockwise manner (illustrated as the clockwise payoff and counterclockwise payoff, respectively). As can be appreciated with reference to FIG. 6, to precisely control the amount of twist per unit length, the spool diameter may be increased or decreased. Therefore, according to one aspect of the present invention the additional step of transferring the optical fiber 55 from a first spool to a second spool of a different size can occur prior to mounting the second spool on the apparatus of FIG. 4.

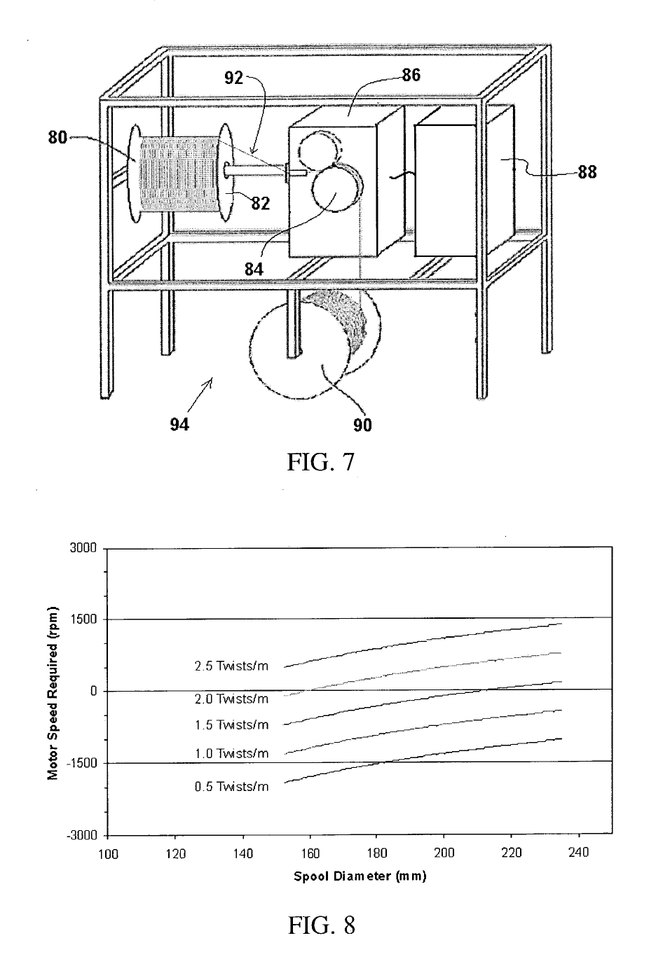

FIG. 7 shows an apparatus 94 to effect active fiber twisting, according to another embodiment of the present invention. The method of active fiber twisting utilizes rotation of the payout spool 80 while optical fiber 92 is pulled over the flange end 82 of the payout spool 80 by one or more wheels 84 associated with an active twisting device 86. In contrast to the method and apparatus described with respect to FIG. 4, in which the spool 50 is fixed in position, facilitating a controlled rotation of the payout spool 80 allows the apparatus 94 to accurately introduce twist in optical fiber 92 regardless of the thickness of a particular spool or the amount of fiber pulled from a spool. Despite this difference, like the apparatus 40 of FIG. 4, twist is induced to the optical fiber 92, and the resultant twisted optical fiber 92 is wound onto a new take-up spool 90.

As explained above with reference to FIG. 4, if the spool is fixed one turn of mechanical twist is imparted for each length of optical fiber 55 corresponding to one spool 50 revolution. However, using the apparatus 94 of FIG. 7 and an identically-sized spool and fixed position from which the fiber is pulled from the spool, e.g., if the optical fiber is pulled in a clockwise fashion while the spool rotates in the clockwise direction, more twist will be imparted into the optical fiber. On the other hand, if the optical fiber is drawn in a clockwise fashion while the spool rotates in the counterclockwise direction, less twist will be imparted into the optical fiber.

The active twisting device 86 controls the rotation speed of the spool, either through direct mechanical control of the spool mounting (e.g., the post upon which the spool is mounted), or through electrical signals that instruct a separate motor that controls the rotation speed of the payout spool 80. The active twisting device 86 is preferably coupled to at least one machine control system 88 to introduce mechanical twist to an optical fiber 92. According to one aspect of the invention, the at least one machine control system 88 is in electrical communication with the active twisting device 86, as illustrated in FIG. 7 by the electrical connection connecting the components. Although the machine control system 88 is illustrated as comprising a portion of the apparatus 94 of FIG. 7, it should be appreciated that the machine control system 88 may be in remote communication with the active twisting device 86. Additionally, the machine control system 88 can comprise, according to one aspect of the present invention, a computer control system in electrical communication with the active twisting device 86. Because the basic concepts of computer control systems are well known in the art, the details of such systems are not discussed herein. It will be appreciated that the active twisting device 86 and machine control system 88 may be combined in one element though they are shown as distinct devices in the embodiment illustrated in FIG. 7. Likewise, where the device 86 and system 88 are separate elements they may be physically located near or far from each other.

It will be appreciated that the payout spool 80 may be rotated in either a clockwise or counterclockwise direction while the active twisting device 86 pulls optical fiber 92 from the end flange 82 of the spool 80 to increase or decrease the amount of twist imparted to the optical fiber 92. By controlling the speed of rotation, the amount of twist can be precisely controlled regardless of, e.g., the diameter of the spool. Referring again to FIG. 5, for instance, the apparatus 94 can slowly increase the spool rotations per minute (rpm), from zero, in a counterclockwise direction where optical fiber is removed in a clockwise fashion, such that the twist imparted to the fiber remains constant as the wound optical fiber circumference changes from reference 74 to reference 72. Therefore, the varying mechanical twist illustrated by the curved lines of FIG. 6, for example, may be avoided.

FIG. 8 is a graph illustrating the twist imparted to optical fiber for various diameter spools and spool rotation speeds using active fiber twisting, according to one embodiment of the present invention. More particularly, the graph shows the number of twists that may be imparted to an optical fiber for a particular spool diameter and spool rotation speed, as measured in rpm. The multiple curved lines in the graph illustrate spool diameters and motor speeds to effect 0.5, 1, 1.5, 2 and 2.5 twists/m of an optical fiber. The mechanical twist illustrated in FIG. 8 and imparted to a spool using the apparatus 94 of FIG. 7 is represented by the following equation:

$$Motor \text{Speed} ( rpm ) = [ ( No . of twists \text{/} m ) - \frac{1}{π \cdot Spool Diameter ( m )} ] * \\ Linespeed ( m \text{/} min )$$

Where the motor speed is equal to the rpm at which the payout spool 80 rotates, the number of twists per meter is the amount of twist imparted to the optical fiber 92 by the apparatus 94, and the linespeed is the speed at which the optical fiber 92 is pulled by the active twisting device 86 from the flange 82 of the spool 80. According to one aspect of the invention, the machine control system 88 and/or active twisting device 86 is used to calculate the payout spool 80 rpm to maintain a desired twist imparted to the optical fiber.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A mechanical twist apparatus, comprising:
a spool, comprising a central section and at least one flange end; and
a pulling device, for pulling fiber, wrapped around the central section of the spool, from the spool,
wherein the pulling device pulls the fiber from the spool over the flange end of the spool, thereby imparting twist to the fiber in such a manner to reduce fiber PMD.

2. The apparatus of claim 1, wherein the fiber comprises optical fiber having a relatively large amount of PMD.

3. The apparatus of claim 1, wherein the apparatus imparts mechanical twist to the fiber in such a manner that the resulting twist imparted to the fiber is less than approximately 2 turns per meter.

4. The apparatus of claim 1, wherein the apparatus imparts mechanical twist to the fiber in such a manner that the resulting fiber has a PMD coefficient of less than approximately 0.1 picoseconds per \sqrt{km}.

5. The apparatus of claim 1, wherein the pulling device pulls the fiber in a direction substantially perpendicular to the direction in which the fiber is wrapped around the central section of the spool.

6. The apparatus of claim 5, wherein the spool is secured such that it cannot rotate.

7. The apparatus of claim 6, wherein the pulling device is operable to impart variable twist to the fiber depending upon the circumference of the spool.

8. The apparatus of claim 5, wherein the spool is rotated as fiber is pulled from the spool by the pulling device.

9. The apparatus of claim 8, further comprising at least one motor, wherein the at least one motor rotates the spool as fiber is pulled from the spool by the pulling device.

10. The apparatus of claim 9, wherein the at least one motor is operable to rotate the spool in the clockwise and counterclockwise directions.

11. The apparatus of claim 9, wherein the at least one motor is in communication with the at least one pulling device, and wherein the at least one pulling device controls the motor and the speed at which the spool rotates.

12. The apparatus of claim 9, further comprising a control system, wherein the control system is operable to control the speed at which the spool rotates.

13. The apparatus of claim 12, wherein the control system is in electrical communication with the pulling device.

14. The apparatus of claim 12, wherein the control system is operable to control the speed at which the spool rotates such that the twist imparted to the fiber reduces the PMD of the fiber.

15. The apparatus of claim 1, further comprising at least one device for measuring the mechanical twist in the fiber and/or the mechanical twist as a function of fiber length of fiber pulled from the spool.

16. The apparatus of claim 15, wherein the at least one device for measuring mechanical twist is controlled automatically.

17. A mechanical twist measurement apparatus, comprising:
a spool, comprising a central section and at least one flange end;
a pulling device, for pulling fiber, wrapped around the central section of the spool, from the spool; and
at least one rotatable device for measuring the mechanical twist in the fiber and/or the mechanical twist as a function of fiber length of fiber pulled from the spool.

18. The apparatus of claim 17, wherein the at least one rotatable device for measuring mechanical twist is controlled automatically.

19. A mechanical twist method, comprising:
wrapping a fiber around a central section of a first spool having at least one flange end;
pulling the fiber from the first spool over the flange end of the first spool, thereby imparting twist to the fiber in such a manner to reduce PMD of the fiber; and
wrapping the fiber having reduced PMD around a second spool.

20. The method of claim 19, wherein wrapping fiber around a central section of the first spool comprises wrapping optical fiber having a relatively large PMD coefficient around a central section of the first spool.

21. The method of claim 19, wherein the resulting twist imparted to the fiber is less than approximately 2 turns per meter.

22. The method of claim 19, wherein the mechanical twist imparted to the fiber results in a fiber with a PMD coefficient less than approximately 0.1 picoseconds per \sqrt{km}.

23. The method of claim 19, wherein pulling the fiber from the first spool over the flange end of the first spool comprises pulling the fiber in a direction substantially perpendicular to the direction in which the fiber is wrapped around the central section of the first spool.

24. The method of claim 23, further comprising the step of securing the first spool so that it cannot rotate.

25. The method of claim 23, further comprising the step of rotating the first spool as the fiber is pulled from the first spool by a pulling device.

26. The method of claim 25, further comprising the step of controllably rotating the first spool using at least one motor in communication with the pulling device.

27. The method of claim 26, further comprising the step of controlling the speed at which the first spool rotates, using a control system, as the fiber is pulled from the first spool.

28. The method of claim 27, wherein the step of controlling the speed at which the first spool rotates further comprises controlling the speed at which the first spool rotates such that the twist imparted to the fiber reduces the PMD of the fiber.

29. The method of claim 19, further comprising the step of measuring the mechanical twist in the fiber and/or the mechanical twist as a function of fiber length of fiber pulled from the spool.

30. The method of claim 29, wherein the mechanical twist measuring step is controlled automatically.

31. A mechanical twist measurement method, comprising:
wrapping a fiber around a central section of a spool;
pulling the fiber from the spool;
controllably rotating the fiber pulled from the spool;
measuring the mechanical twist in the fiber and/or the mechanical twist as a function of fiber length of fiber pulled from the spool, by determining the number of fiber counter rotations needed to relax the fiber pulled from the spool.

32. The method of claim 31, wherein the mechanical twist measuring step is controlled automatically.
